(19) United States
(12) Patent Application Publication
(10) Pub. No.: US 2019/0217131 A1
(43) Pub. Date: Jul. 18, 2019

(54) Method and Arrangement for Identifying Obstacles on Escape Routes

(71) Applicant: Siemens Schweiz AG, Zürich (CH)

(72) Inventor: Oliver Zechlin, Zug (CH)

(73) Assignee: Siemens Schweiz AG, Zürich (CH)

(21) Appl. No.: 16/333,758

(22) PCT Filed: Aug. 30, 2017
(86) PCT No.: PCT/EP2017/071768

§ 371 Date: Mar. 15, 2019

(30) Foreign Application Priority Data
Sep. 20, 2016 (DE) 10 2016 217 950.0

(51) Int. Cl. A62B 3/00; G06K 9/00; H04N 5/232

(52) U.S. Cl. CPC A62B 3/00; H04N 5/23222; G06K 9/00744; G06K 9/00664

(57) ABSTRACT

Various embodiments include methods and arrangements for identifying obstacles on escape routes, in particular in buildings, wherein a desired state of the escape route is stored in particular in a corresponding data model on a computer system as a reference state; wherein an actual state of the escape route is acquired by the computer system and is mapped in the data model; and wherein by comparing the actual state with the stored reference state determines whether the escape route has obstacles.

### CROSS-REFERENCE TO RELATED APPLICATIONS

This application is a U.S. National Stage Application of International Application No. PCT/EP2017/071768 filed Aug. 30, 2017, which designates the United States of America, and claims priority to DE Application No. 10 2016 217 950.0 filed Sep. 20, 2016, the contents of which are hereby incorporated by reference in their entirety.

### TECHNICAL FIELD

The present disclosure relates to directing escape routes. Various embodiments may include methods and devices for identifying obstacles on escape routes, in particular in buildings.

### BACKGROUND

Escape and evacuation routes are prescribed by law in buildings and public facilities or events. In accordance with the Wikipedia entry, an escape route is a specially marked route, in most cases within a building, which, in the case of necessary escape, leads quickly and safely outside or into a safe area. The main purpose of an escape route is self-rescue. An exit which leads directly outside or into a safe area is referred to as an emergency exit. Escape and evacuation routes in buildings are parts of a structural installation which are required under building law (e.g. office buildings, railway stations, factory buildings), by way of which individuals are able to leave the building or be rescued.

Escape and evacuation routes or emergency exits in buildings must be kept free, i.e. free of obstacles, so that they are able to fulfill their purpose. Escape routes, evacuation routes or emergency exits are nowadays often monitored manually, by instructing individuals to carry out a visual examination on site. In subareas monitoring is also carried out by way of closed circuit television (CCTV), wherein an individual-oriented visual examination of the recordings is also carried out here by corresponding personnel.

This type of monitoring of the escape routes, evacuation routes or emergency exits is expensive, subjective and not always reliable.

### SUMMARY

The teachings of the present disclosure describe methods for identifying obstacles on escape routes which is reliable and easy to realize. For example, some embodiments include a method for identifying obstacles on escape routes, in particular in buildings, wherein a desired state of the escape route is stored in a memory of a computer system, in particular in a corresponding data model, as a reference state; wherein an actual state of the escape route is acquired by the computer system and is mapped in the data model; and wherein any obstacles on the escape route are identified by a comparison of the actual state and the stored reference state. The actual state and desired state are each represented in a data model by a corresponding notation or by a respective pattern (e.g. sequence of bits). Deviations can be very easily and very quickly identified by a simple alignment of the respective pattern in the data model. The alignment can be carried out, for instance, by a simple mapping of the actual state on the desired state. A complicated image analysis e.g. by pattern recognition algorithms, is not necessary.

As another example, some embodiments include a method for identifying obstacles (H) on escape routes (FW1, FW2), in particular in buildings (GB1, GB2), (VS1) wherein a desired state (SZ) of the escape route (FW1, FW2) is stored as a reference state (Ref) in a memory (DB) of a computer system (S); (VS2) wherein an actual state (IZ) of the escape route (FW1, FW2) is acquired by the computer system (S); and (VS3) wherein by comparing the actual state (IZ) with the stored reference state (Ref) it is possible to determine whether the escape route (FW1, FW2) has a obstacle (H).

In some embodiments, the desired state (SZ) of the escape route (FW1, FW2) is carried out on site in the building (GB1, GB2) by an optical and/or acoustic measurement of the escape route (FW1, FW2).

In some embodiments, the optical and/or acoustic measurement of the escape route (FW1, FW2) is carried out by a mobile device (MG1, MG2).

In some embodiments, the desired state (SZ) of the escape route (FW1, FW2) is carried out by evaluating the building plan.

In some embodiments, the actual state of the escape route (FW1, FW2) is acquired by means of a further mobile device (WMG1, WMG2) by way of photo and/or video recordings and wherein the further mobile device (WMG1, WMG2) is designed to transmit the actual state (IZ) of the escape route (FW1, FW2) to the computer system (S).

In some embodiments, based on the spatial position of the further mobile device (WMG1, WMG2), a user (B1, B2) of the further mobile device (WMG1, WMG2) is instructed by the computer system (S) to produce a photo and/or video recording of an escape route (FW1, FW2) located in the vicinity and to transmit the same to the computer system (S).

In some embodiments, the respective photo and/or video recordings comprise spatial metadata, and wherein on the basis of the respective spatial metadata in the computer system (S), the spatial coordinates of a respectively checked escape route (FW1, FW2) are verified.

As another example, some embodiments include a device for carrying out a method as described herein, the device comprising: a mobile device (MG1, MG2), equipped with a corresponding measuring and/or recording device (MAV1, MAV2) for acquiring the desired state (SZ) of the escape route (FW1, FW2), wherein the mobile device (MG1, MG2) is designed to report the desired state (SZ) to a server (S); a storage device (DB) for storing the desired state (SZ) of the escape route (FW1, FW2) as a reference state (Ref); and a server (S) which is designed to obtain actual state data (IZ) of the escape route (FW1, FW2), in particular one or more photo recordings, acquired by a further mobile device (WMG1, WMG2). The server (S) is also designed to determine by means of a comparison of the obtained actual state data (IZ) of the escape route (FW1, FW2) with the reference state (Ref) of the escape route (FW1, FW2) whether an obstacle (H) or a blockage exists.

In some embodiments, there is a device (SAT, IPS) for spatial determination of the further mobile device (WMG1, WMG2) wherein, on the basis of the spatial position of the further mobile device (WMG1, WMG2), a user (B1, B2) of the mobile device (WMG1, WMG2) can be instructed by the server (S) to take one or more photo and/or video recordings of one or more escape routes (FW1, FW2) located in the vicinity of the further mobile device (WMG1, WMG2) and to transmit the same to the server (S).

In some embodiments, the further mobile device (WMG1, WMG2) is a mobile communication terminal (WMG1, WMG2) of a user (B1, B2) which is designed to receive mini tasks (MA), wherein the user (B1, B2) can be instructed by a mini task (MA) by way of the mobile communication terminal (WMG1, WMG2) to take one or more photo recordings of a specific escape route (FW1, FW2) and to transmit the same to the computer system (S).

### BRIEF DESCRIPTION OF THE DRAWINGS

The teachings herein and advantageous embodiments thereof are explained using the example of the figures below, in which:

FIG. 1 shows a first exemplary arrangement for identifying obstacles and/or blockages on escape routes incorporating teachings of the present disclosure;

FIG. 2 shows a second exemplary arrangement for identifying obstacles and/or blockages on escape routes incorporating teachings of the present disclosure; and

FIG. 3 shows an exemplary flow chart for a method for identifying obstacles and/or blockages on escape routes incorporating teachings of the present disclosure.

### DETAILED DESCRIPTION

In some embodiments, the desired state of the escape route is carried out by an optical and/or acoustic measurement of the escape route on site in the building. The desired state of an escape route can be measured by a laser scan, for instance. A 3D mapping of the escape route can be produced by vertical and horizontal laser recordings, which are used as the desired or reference state. In the data model, the desired or reference state can be shown as a three-dimensional scatter plot. An optical measurement can also take place by means of cameras with a corresponding resolution, i.e. by means of high-resolution cameras. The measurement can also take place by means of acoustic methods, e.g. ultrasound or echo evaluation (e.g. measurement by ultrasound reflection). It is also possible to combine optical and acoustic methods for a measurement. The desired state of the respective escape routes of a building can be carried out with a safety-related approval of the building, for instance. The desired state of an escape route is in particular a free, i.e. unblocked, escape route.

In some embodiments, the optical and/or acoustic measurement of the escape route is carried out by a mobile device. A trolley with corresponding measuring equipment can be used as a mobile device, for instance, said trolley being moved through the building by an operator, such as e.g. the M3 trolley by the company Navvis GmbH. A mobile robot, e.g. a driving robot with corresponding measuring devices which drive around the corresponding building autonomously or semi autonomously, can also be used as a mobile device for acquiring the desired state. A drone (unmanned aircraft) with corresponding measuring devices which moves autonomously in and/or around the building can also be used as a mobile device for acquiring the desired state. Using a drone inter alia can be used very easily in stairs or stairwells. A drone can be used autonomously (with corresponding programming and control), semiautonomously, or manually (i.e. controlled by an operator).

In some embodiments, the desired state of the escape route is carried out by evaluating the building plan. A building plan can be digitized by means of scanning or digital photography and mapped into a digital data format or data model. Escape routes are typically identified accordingly in a building plan, and the scale of the building plan is also known. The desired state of the respective escape routes is determined on the basis of the scale and dimensions of the building plan and mapped in the data model as the respective reference state. The reference state determination can also take place on the basis of the building plan and in combination with measurement data which has been acquired by a mobile device.

In some embodiments, the actual state of the escape route may be acquired via photo and/or video recordings by means of a further mobile device (e.g. mobile communication terminal (e.g. smartphone, tablet computer), driving robot, drone) and wherein the further mobile device is designed to transmit the actual state of the escape route to the computer system (e.g. web server) (e.g. by means of a corresponding app). The actual state of the escape route may be also acquired by way of a mobile device, e.g. by a mobile communication terminal of a user. Mobile communication terminals are nowadays widespread and equipped with high-quality, in particular high-resolution cameras. Photo and/or video recordings of the actual state of escape routes can be transmitted via corresponding communication mechanisms from mobile communication terminals to the computer system (e.g. servers in a building management system). E.g. via email, Messenger message or via a web service.

In some embodiments, a user of the mobile device is instructed by the computer system, on the basis of the spatial position of the further mobile device, to create a photo and/or video recording of an escape route located in the vicinity and to transmit the same to the computer system. As a result, users who stay in the vicinity of a specific building with their mobile communication devices, may be instructed to take one or more photo recordings of escape routes located in these buildings and to transmit the same to the computer system. As a result, there are no travel expenses for the user. The spatial position of the mobile communication terminals can be determined by position determination systems (e.g. satellite-assisted systems such as GPS or by indoor position determination system (IPS), like e.g. iBeacons). Mobile communication terminals (e.g. smartphones) are typically equipped with corresponding software and hardware.

In some embodiments, the respective photo and/or video recordings comprise spatial metadata, and wherein on the basis of the respective spatial metadata in the computer system, the spatial coordinates of a respective checked escape route are verified. This thus ensures that the respective desired and actual states belong to the same escape route. The desired state data and the actual state data advantageously comprise spatial coordinates (position data) of the respective escape routes.

The infrastructure required to carry out the methods herein is typically already present, e.g. mobile communication terminals (e.g. smartphones) with a high-resolution camera. The corresponding software can be loaded onto the mobile communication terminals as an app, for instance. This can be carried out by means of an Internet download, for instance, or also by scanning in a corresponding QR code which is attached to the building.

In some embodiments, an arrangement for identifying obstacles and/or blockages on escape routes, in particular in buildings, comprises:
a mobile device, equipped with a corresponding device for acquiring the desired state of the escape route, wherein the mobile device is configured to report the desired state to a server;
a storage device for storing the desired state of the escape route as a reference state, in particular in a corresponding data model;
server which is designed to obtain actual state data of the escape route acquired by a further mobile device, in particular one or more photo recordings;
wherein the server is also designed to determine by means of a comparison of the obtained actual state data of the escape route with the reference state of the escape route, whether an obstacle or a blockage exists. The arrangement allows obstacles and/or blockages on escape routes, in particular in buildings, to be identified effectively. An efficient safety management system is inter alia therefore possible. The arrangement can be realized from commercially available hardware and software components.

In some embodiments, the arrangement comprises equipment for spatial determination of the further mobile device, wherein, on the basis of the spatial position of the further mobile device, a user of the mobile device can be instructed by the server to take one or more photo and/or video recordings of one or more escape routes located in the vicinity of the further mobile device and to transmit them to the server. As a result, there are no travel expenses for the user. Equipment for determining the location (position determination systems), e.g. GPS or IPS are widespread and need not be provided as extra. Nowadays mobile communication terminals are equipped with radio transmitters, which can be located by position determination systems. On the basis of this location data, mobile communication terminals can be instructed by the computer system (e.g. as a web service) in a dedicated manner.

In some embodiments, the further mobile device is a mobile communication terminal of a user, which is designed to receive mini tasks, wherein the user can be instructed by a mini task by way of the mobile communication device, to take one or more photo recordings of a specific escape route and to transmit them to the computer system (e.g. web server or a web service). The user can be registered with a mini task marketplace (e.g. Amazon Mechanical Turk) and receive corresponding tasks.

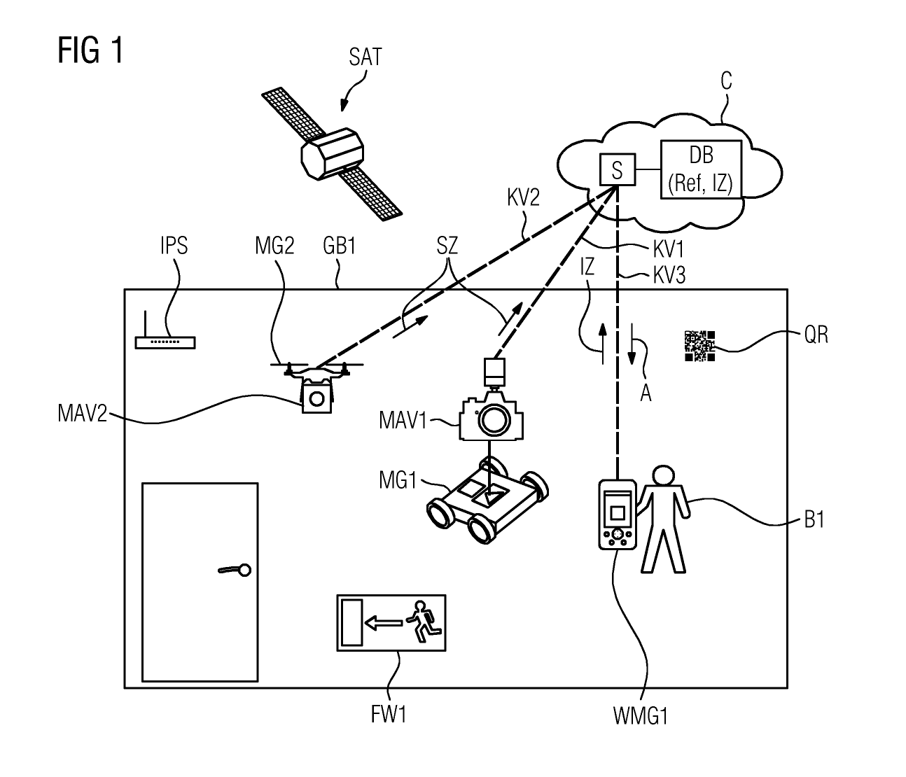

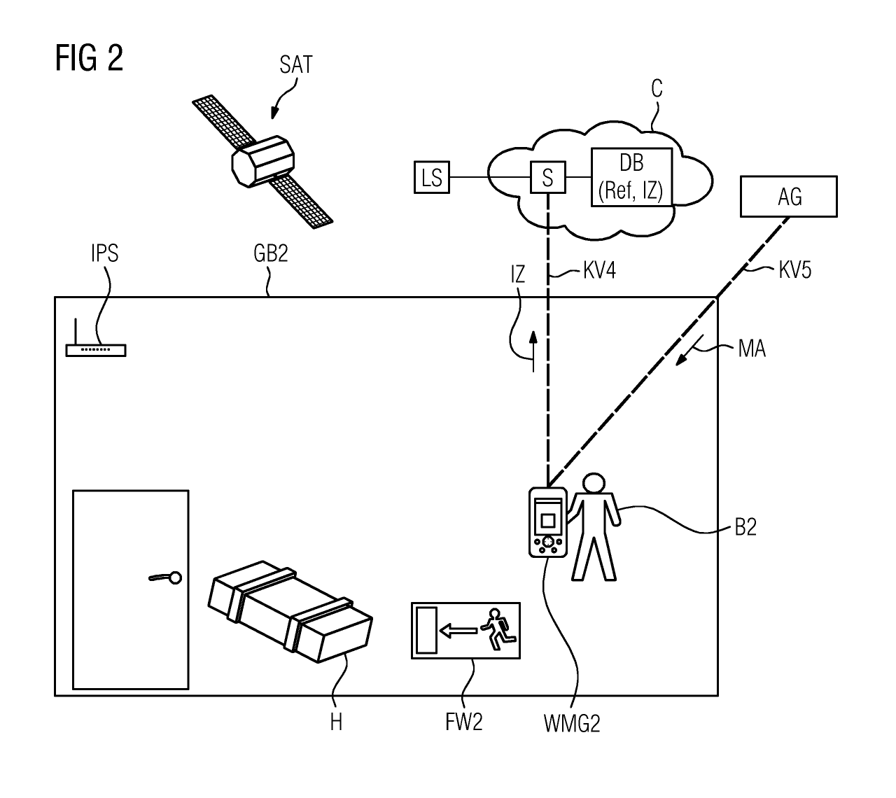

FIG. 1 shows a first exemplary arrangement for identifying obstacles (H; see FIG. 2) and/or blockages on escape routes FW1, in particular in buildings GB1. The exemplary arrangement comprises:
a mobile device MG1, MG2 equipped with a corresponding measuring and/or recording device MAV1, MAV2 for acquiring the desired state of the escape route FW1, wherein the mobile device MG1, MG2 is designed to report the desired state SZ to a server S;
a storage device DB for storing the desired state SZ of the escape route FW1 as a reference state Ref;
a server S, which is designed to obtain actual state data IZ of the escape route FW1 acquired by a further mobile device WMG1, in particular one or more photo recordings;
wherein the server S is also designed to determine, by means of a comparison of the obtained actual state data IZ of the escape route FW1 with the reference state Ref of the escape route FW1, whether an obstacle (H; see FIG. 2) or a blockage exists.

The desired state SZ may be stored as a reference state Ref and the obtained respective actual state data of the escape route FW1 in the storage device DB in a suitable data model or data format, which easily allows for a comparison of the desired state SZ with respective actual states IZ, in particular by simple mapping of a respective actual state IZ to the desired state SZ or the reference state Ref. E.g. Desired and actual state can be analyzed by a corresponding parser and accordingly prepared syntactically, in order to carry out the comparison by means of a corresponding program. In principle, a comparison can also take place by means of pattern recognition or image analysis methods. The desired state SZ of an escape route FW1 is in particular a free escape route, e.g. an accessible escape route without obstacles.

The desired state SZ may be compared automatically with an actual state IZ, whenever a corresponding actual state IZ is registered. The comparison of the desired state SZ with the registered actual states IZ can also take place in a batch run, e.g. at specific, defined points in time. If deviations between the desired state SZ (or the reference state Ref) and an actual state IZ are identified, corresponding measures are advantageously introduced automatically by the server S. E.g. instructing a caretaker to carry out an inspection on site and to remove the obstacle (H; see FIG. 2) so that the escape route FW1 is free again.

If deviations between the desired state SZ (or the reference state Ref) and an actual state IZ are identified, a message can also be sent from the server S to a control center (in particular building control center), for instance. Operating personnel in the control center can then introduce further measures (e.g. inspection of the escape route).

CSV (comma separated values), RTF (Rich Text Format), XML, Unicode, or JSON (Java Script Object Notation) can be used as the data model or data format, for instance. A data format is advantageously used, for which commercial parsers are available (in particular “commercials off the shelf”). For JSON, parsers exist in many widespread programming languages. Furthermore, JSON is independent of programming languages. If necessary, a conversion into the corresponding data model or data format is carried out in the server S. When video sequences (as actual state IZ) are compared with a reference state Ref, the video sequence may be broken down into a sequence of individual images, which can each be compared with the reference state Ref.

The reference states Ref may be stored in a building information model (BIM). Reference states Ref and actual states IZ are advantageously mapped in the data model of the building information model (BIM). The comparison or alignment between the reference state and actual state can therefore take place in the data model of the building information model (BIM).

The exemplary arrangement according to FIG. 1 may comprise equipment SAT, IPS for spatial determination of the further mobile device WMG1, wherein, on the basis of the spatial position of the further mobile device WMG1, a user B1 of the further mobile device WMG1 can be instructed by the server S to take one or more photo and/or video recordings of one or more escape routes FW1 located in the vicinity of the further mobile device WMG1 and to transmit them to the server S. The equipment SAT, IPS for spatial determination can be a satellite-assisted position determination system SAT (e.g. GPS) and/or an indoor position determination system IPS (e.g. iBeacon, based on BLE (Bluetooth Low Energy).

In the exemplary representation according to FIG. 1, the mobile devices which are each equipped with a corresponding measuring and/or recording device MAV1, MAV2 for acquiring the desired state of the escape route FW1 are a driving robot MG1 and/or a drone MG2. The driving robot MG1 and the drone MG2 can move autonomously in the building GB1. Buildings GB1 are often equipped with indoor position determination systems IPS. The driving robot MG1 and the drone MG2 can move autonomously in the building GB1 using corresponding navigation and control software. The driving robot MG1 and the drone MG2 can also each be moved through the building GB1 controlled by an operator.

The measuring and/or recording devices MAV1, MAV2 with which the driving robot MG1 and the drone MG2 may be high-resolution cameras, for instance, which may produce digitized images or video recordings of the escape route FW1 and forward same as a desired state SZ via suitable communication links KV1, KV2 (e.g. via corresponding radio links, WLAN, Internet, mobile radio link) to the server S.

The measuring and/or recording devices MAV1, MAV2 can also be laser cameras, in particular suited to producing three-dimensional recordings. The desired state SZ of the escape route KW1 can be measured by a laser scan using a laser camera. A 3D mapping of the escape route FW1 which is used as the desired SZ or reference state Ref can be produced by vertical and horizontal laser recordings. In a corresponding data model, the desired SZ or reference state Ref can be shown as a three-dimensional point cloud.

The measuring and/or recording devices MAV1, MAV2 can also be designed to carry out the measurement of the desired state SZ of an escape route FW1 using acoustic methods, e.g. ultrasound, sonography or echo evaluation (e.g. measurement by means of acoustic wave reflection). It is also possible to combine optical and acoustic methods for a measurement.

The server S (e.g. workstation, PC) may be equipped with corresponding input/output means, communication mechanisms, memory and processor power). The server converts (if necessary) the received desired state SZ into a corresponding data model or data format for the reference state Ref and stores the reference state Ref for a free escape route FW1 in a memory or in a database DB. The server S and the database DB are advantageously disposed in a cloud or in a cloud infrastructure. Therefore, it is possible to offer the comparison between the desired and actual state of an escape route FW1 as software-as-a-service (SaaS), e.g. as a web service.

The server S is designed to obtain actual state data IZ of the escape route FW1 acquired by a further mobile device WMG1, in particular one or more photo recordings, by way of a corresponding communication link KV3 (e.g. radio link, WLAN, Internet, mobile radio link). The further mobile device WMG1 is a mobile communication terminal (e.g. smartphone, tablet computer), for instance. Mobile communication terminals WMG1 are nowadays equipped with powerful cameras. A user B1 uses the mobile communication terminal WMG1 (e.g. smartphone) to take one or more photos and/or video sequences of the escape route FW1 and send these recordings via the communication link KV3 as an actual state (actual state data) IZ to the server S. The server S converts this actual state data IZ into a corresponding data model or data format, so that a comparison or alignment of the actual state data IZ with the desired state SZ (or the reference state Ref) can be carried out. The desired states SZ and the actual states IZ each advantageously comprise spatial information (spatial coordinates). As a result, it is easily possible to verify whether the desired state SZ and actual state IZ each relate to the same escape route FW1. The spatial coordinates can be determined by the position determination systems SAT, IPS.

The user B1 may receive a task A from the server to detect actual states IZ of escape routes FW1 in a building GB1. The user B1 may be, e.g. a visitor to the building or a caretaker or facility manager for the building GB1. The software (e.g. app) for the further mobile device WMG1 for communication with the server S can be carried out by means of a corresponding download (e.g. Internet download) or e.g. by scanning in a QR code which is applied in or on the building GB1.

The further device WMG1 can in principle also be used as a mobile device for acquiring the desired state SZ of an escape route FW1.

FIG. 2 shows a second exemplary arrangement for identifying obstacles H and/or blockages on escape routes FW2. In the representation according to FIG. 2, the mobile device (e.g. driving robot, drone, mobile communication terminal) for acquiring the desired state SZ of the escape route FW2 is not shown. The reference state Ref of the escape route FW2 is however stored in the database DB for a comparison or alignment with registered actual states IZ of the escape route FW2 in a corresponding format or data model.

In the representation according to FIG. 2, the escape route FW2 is blocked by an obstacle H (e.g. a box). The escape route FW2 is only accessible with difficulty as a result of the obstacle H, the obstacle H therefore represents a blockage of the escape route FW2. In the representation according to FIG. 2, a user B2 is equipped with a further mobile device WMG2, in particular a mobile communication terminal (e.g. smartphone). The user B2 takes one or more photos or videos of the obstacle H using his mobile communication terminal WMG2 and sends these recordings as an actual state IZ via the communication link KV4 (e.g. a suitable radio link) to the server S for comparison of the actual state IZ with the reference state Ref of the escape route FW2.

The server S carries out the comparison or alignment of the actual state IZ of the escape route FW2 with the reference state Ref of the escape route FW2. When a blockage is identified, the server S sends a corresponding fault indication relating to the escape route FW2 to the control center LS (building control center). Measures for removing the obstacle H can be introduced in the control center LS, e.g. instructing service personnel to clear the obstacle H. It is also possible for the server S to introduce measures for removing the obstacle H autonomously. The server S and the database DB may be realized in a cloud infrastructure (cloud computing). The database DB may comprise data models (data representations) of the desired states, mapped as reference states Ref, of all escape routes FW2 located in the building GB2.

In some embodiments, the further mobile device WMG2 is a mobile communication terminal (e.g. smartphone, tablet computer) of a user B2, which is designed to receive mini tasks MA, wherein the user B2 can be instructed by a mini task MA by way of the mobile communication terminal WMG2 to take one or more photo recordings of a specific escape route FW2 and to transmit the same to the computer system S. The user B2 can be registered with a mini task marketplace AG (e.g. Amazon Mechanical Turk) and receive corresponding tasks MA.

The position determination system SAT, IPS makes it known to the employer AG (e.g. mini task marketplace) that a corresponding user B2 is located in or in the vicinity of the building GB2. By way of example, the escape route FW2 is located in the building GB2. The user B2 is instructed by the employer AG (e.g. mini task marketplace) to transmit one or more photos and/or videos as an actual state IZ to the server KV4. When the user B2 registers with the employer AG (e.g. mini task marketplace), a URL can be transmitted to the user on his/her mobile communication terminal WMG2, for a download of a corresponding app, in order to communicate with the server S. The communication link KV5 between the employer AG and the mobile communication terminal WMG2 is advantageously a radio link (e.g. WLAN, Internet, mobile radio link). The position determination system may be e.g. a satellite-assisted system (e.g. GPS) or an indoor position determination system IPS (e.g. based on iBeacons, BLE (Bluetooth Low Energy).

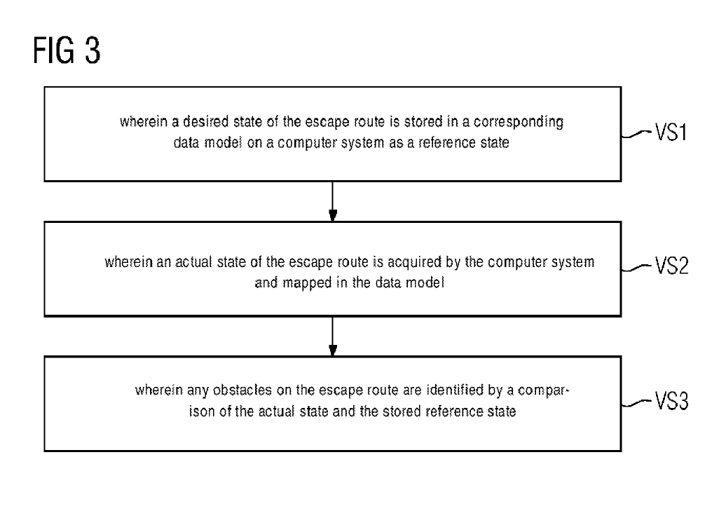

FIG. 3 shows an exemplary flow chart for a method for identifying obstacles and/or blockages on escape routes,
(VS1) wherein a desired state of the escape route is stored in a memory of a computer system as a reference state;
(VS2) wherein an actual state of the escape route is acquired by the computer system; and
(VS3) wherein any obstacles on the escape route are identified by a comparison of the actual state and the stored reference state.

The actual state and desired state may be each represented or mapped in a data model by a corresponding notation or by respective pattern (e.g. sequence of bits). Deviations can be very easily and very quickly identified by a simple alignment of the respective pattern in the data model. The alignment can be carried out, for instance, by a simple mapping of the actual state on the desired state. A complicated image analysis e.g. by pattern recognition algorithms, is not necessary. The method can in principle be realized with commercially available hardware and software components (e.g. server, databases, Internet, smartphones). The desired state of the escape route (i.e. a free escape route) may be recorded by a mobile device (e.g. drone, driving robot) using corresponding measuring and recording equipment (e.g. high resolution camera, laser camera) and transmitted to the computer system (e.g. server in cloud). The actual state of the escape route may be recorded by a further mobile device (e.g. mobile terminal (e.g. smartphone)) by means of photos and/or videos and these recordings are transmitted from the further mobile device to the computer system for acquisition purposes. The alignment between the reference state and the actual state is carried out in the server.

Advantages of the methods and arrangements described herein are inter alia:
use of sensor recordings (e.g. “NavVis” scan of inside spaces) like e.g. laser scan point clouds and camera recordings on/around/in the building, especially those with safety-relevant reference (e.g. safety areas; escape routes; fire doors). This sensor material is defined as “desired” or as a “desired state” and is used as a reference (reference state).
More up-to-data images/scans (e.g. laser point clouds) are aligned with the available reference images (the “desired”) on a server. If the image-analyzing system now establishes a deviation from “desired” (desired state) and “actual” (actual state), an alarm and/or an action is triggered. Example: a goods pallet is present as an obstacle in the escape route. Hereupon a instructed individual or a robot operating autonomously or semiautonomously can be sent on site to take measures in order to eliminate the safety breach, in order to reestablish the “desired” state or allow the same to restore itself.
All individuals (crowd) can in principle communicate the presence of safety problems using an app/service. This can take place actively or passively.
   Actively: Initiative image acquisition and forwarding. This will presumably take place primarily in access-restricted areas, such as companies. There employees or service providers operating there would draw up reports and indicate safety-related problems. The designed app/service at least also increases the “awareness” of the problem of cluttered corridors/escape doors.
   Passively: in more publically accessible areas, image material which from there has ended up “on the Internet”, e.g. on social platforms such as Instagram, Facebook, Twitter, is aligned with the available reference image material. A passive creation and transmission by the service provider in the building is also possible, however, so that mobile cleaning/transportation trolleys cameras can be used to acquire image material “en passent” and use the same for alignment with the image reference material.
In addition to individuals, photo/image material can also be produced and transmitted by fully or partially autonomously operating robots (air (drone) or ground). If a CCTV video monitoring system is to be available, its image material can also be used for automatic alignment with the reference image material.
Furthermore, individuals can be addressed and remunerated actively. An example of a digital microtask platform: e.g. Amazon Mechanical Turk (https://www.mturk.com/)
   mini tasks can be assigned and allocated on this. In this way a system can be used to initiate, i.e. using an individual located there, a check of safety-relevant areas such as escape doors, escape passages etc., so that said individual has consented to such an offer by means of app/service etc. to take photos and/or videos of the surrounding area, in order then to align this available image material with the reference material.
If an A1/Bot service is available, this can lead technologically less experienced users in particular through the acquisition process and offer assistance and instruction with corresponding queries.
In the presence of a positioning infrastructure, be it satellite (GPS etc.) in particular outside of a building, radio (Bluetooth beacons etc.) or other positioning technology (e.g. image fingerprinting, magnetic field), tasks can be offered or allocated selectively to individuals in the vicinity of a known location.
By embedding the location-related metadata in the image/video material when a positioning infrastructure is present, it is possible to ensure that the material is (probably) real. Furthermore, this location metadata simplifies and speeds up the server-side alignment with the reference material (in particular the respective reference data).
If an alignment result, or alignment partial result (can) be determined immediately, and the individual and/or the device which has produced and transmitted the “actual” state is still on site, if there is any “suspicion” of deviation further sensor information can also still be requested and produced by the device on site. This may be a current radio wave and/or Earth's magnetic field “fingerprint” for instance. This can also take place by default, and enrich the visual sensor information.
The data is stored in a database or the cloud and is therefore available as proof or also for statistical analysis.
Up-to-date or more up-to-date information relating to the actual state as areas currently not monitored with CCTV; so that a building or a campus is passively safer since the probability and frequency of hidden escape route areas is minimized.
A prompt reproduction of the safe original state (“desired”) is enabled.
Use of a reference image, or reference sensor information as “desired”.
Offline operation possible, i.e. created sensor information (“actual”), e.g. photos/video/laser scan/Earth's magnetic field I radio wave finger print are acquired on site and possibly transmitted to the server, a direct online link is not needed.
Use of the “crowd” as “dynamic CCTV”.
Ability to use autonomous or semiautonomous robots instead of dedicated safety officers.
Active and passive creation of the onsite recording.
Possibility of evaluating sensor material which has been provided on the Internet (e.g. social media).
Use of metadata (positioning information within buildings) to increase the image or laser scan information generated.
The invention is one step further in the direction of “digital building” and use of data stock available therewith.

### REFERENCE SIGNS

SAT, IPS position determination system
B1, B2 user
MG1, MG2 mobile device
MAV1, MAV2 measuring and/or recording device
WMG1, WMG2 further mobile device
C cloud
S server
DB database
GB1, GB2 building
FW1, FW2 escape route
H obstacle
KV1-KV5 communication link
SZ desired state
Ref reference state
IZ actual state
LS control center
QR QR Code
A task
MA mini task
AG employer
VS1-VS3 method step

What is claimed is:

1. A method for identifying obstacles on escape routes, the method comprising:
storing a desired state of the escape route as a reference state in a memory of a computer system;
acquiring an actual state of the escape route by the computer system; and
comparing the actual state with the stored reference state to determine whether the escape route has a obstacle.

2. The method as claimed in claim 1, further comprising defining the desired state of the escape route on site in the building using an optical and/or acoustic measurement of the escape route.

3. The method as claimed in claim 2, wherein the optical and/or acoustic measurement of the escape route is carried out by a mobile device.

4. The method as claimed in claim 1, further comprising defining the desired state of the escape route by evaluating the building plan.

5. The method as claimed in claim 1, wherein:
acquiring the actual state of the escape route with a mobile device using photo and/or video recordings; and
the mobile device transmits the actual state of the escape route to the computer system.

6. The method as claimed in claim 1, further comprising instructing an user, based on a spatial position of an associated mobile device, by the computer system to produce a photo and/or video recording of an escape route located in the vicinity and to transmit the same to the computer system.

7. The method as claimed in claim 1, wherein:
the respective photo and/or video recordings comprise spatial metadata; and
on the basis of the respective spatial metadata in the computer system, the spatial coordinates of a respectively checked escape route are verified.

8. (canceled)

9. An arrangement for identifying obstacles and/or blockages on escape routes, the arrangement comprising:
a mobile device equipped with a measuring and/or recording device for acquiring a desired state of a respective escape route, the mobile device configured to report the desired state to a server;
a storage device for storing the desired state of the escape route as a reference state; and
a server configured to obtain actual state data of the escape route acquired by a further mobile device;
wherein the server compares the obtained actual state data of the escape route with the reference state of the escape route to determine whether an obstacle or a blockage exists.

10. An arrangement according to FIG. 9, further comprising a device for spatial determination of the further mobile device;
wherein, on the basis of the spatial position of the further mobile device, an associated user can be instructed by the server to take one or more photo and/or video recordings of one or more escape routes located in the vicinity of the further mobile device and to transmit the same to the server.

11. The arrangement as claimed in claim 9, wherein:
the further mobile device comprises a mobile communication terminal associated with a user, the mobile communication terminal configured to receive mini tasks; and
a mini task includes instructions to take one or more photo recordings of a specific escape route and to transmit the same to the computer system.
